(19) United States
(12) Patent Application Publication
(10) Pub. No.: US 2017/0344106 A1
(43) Pub. Date: Nov. 30, 2017

(54) Reducing Hazards During Mobile Device Use

(71) Applicant: International Business Machines Corporation, Armonk, NY (US)

(72) Inventors: Guy M. Cohen, Ossining, NY (US); Lior Horesh, North Salem, NY (US); Raya Horesh, North Salem, NY (US); Marco Pistoia, Amawalk, NY (US)

(21) Appl. No.: 15/163,294

(22) Filed: May 24, 2016

(51) Int. Cl. G06F 3/01; H04W 4/02; G06F 3/0484; G06F 3/0346; G06F 3/03; G06T 7/20; G09G 5/38; H04W 88/02

(52) U.S. Cl. CPC G06F 3/013; G06T 7/20; H04W 4/027; G09G 5/38; G06F 3/017; G06F 3/04845; G06F 3/0346; G06F 3/0304; H04W 88/02

(57) ABSTRACT

Techniques for reducing hazards associated with mobile device use are provided. In one aspect, a method for increasing user awareness during mobile device use is provided. The method includes the steps of: detecting, by the mobile device, walking motion of the user; and if the mobile device is displaying information to the user, shifting attention of the user away from the mobile device towards a surrounding environment.

### FIELD OF THE INVENTION

The present invention relates to mobile technology, and more particularly, to techniques for reducing hazards associated with mobile device use.

### BACKGROUND OF THE INVENTION

With advancements in mobile technology and wireless connectivity, people are focusing more of their attention on their devices rather than to their surrounding environment. As such, accidents that could otherwise be easily avoided, such as walking into an obstacle are unfortunately more frequent. See, for example, Schabrun et al., “Texting and Walking: Strategies for Postural Control and Implications for Safety,” PLoS One 9(1): e84312 (January 2014).

Thus, there is a need to include safety features in applications that are used on mobile devices that would discourage unsafe practices. Taking the texting application as an example, there are currently several texting applications that provide a transparent background. The application is making use of the device camera, so the view in front of the devices is displayed as the background to the texting application. See, for example, U.S. Patent Application Publication Number 2014/0085334 by Payne, entitled “Transparent Texting.” However, a better approach would be to dissuade such behavior to reduce the hazard, rather than to rely on the camera image and continue texting.

Accordingly, improved techniques for reducing hazards associated with mobile device use would be desirable.

### SUMMARY OF THE INVENTION

The present invention provides techniques for reducing hazards associated with mobile device use. In one aspect of the invention, a method for increasing user awareness during mobile device use is provided. The method includes the steps of: detecting, by the mobile device, walking motion of the user; and if the mobile device is displaying information to the user, shifting attention of the user away from the mobile device towards a surrounding environment.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for increasing user awareness when using a mobile device according to an embodiment of the present invention;

FIG. 2 is a diagram illustrating an exemplary methodology for changing the way the mobile device interacts with a user by detecting user eye movements and blanking the screen according to an embodiment of the present invention;

FIG. 3 is a diagram illustrating an exemplary methodology for changing the way the mobile device interacts with a user by manipulating objects on the screen according to an embodiment of the present invention;

FIG. 4 is a diagram illustrating an example of manipulating objects on the screen in a manner so as to prompt the user to move/shake the mobile device to restore the content to the center of the screen according to an embodiment of the present invention; and

FIG. 5 is a diagram illustrating an exemplary apparatus for performing one or more of the methodologies presented herein according to an embodiment of the present invention.

### DETAILED DESCRIPTION OF PREFERRED EMBODIMENTS

Provided herein are techniques for reducing hazards associated with mobile device use. The present techniques interface with mobile applications (for example, a texting application, email application (or “app”), internet browser, etc.) so as to increase users awareness to their surroundings once the mobile device detects that a user is engaged in walking. The present techniques leverage the capabilities of current mobile technology which typically includes a motion processor that can accurately measure/detect an activity such as walking. The present techniques are generally applicable to any type of mobile device including, but not limited to, smartphones, smartwatches, smartglasses, etc.

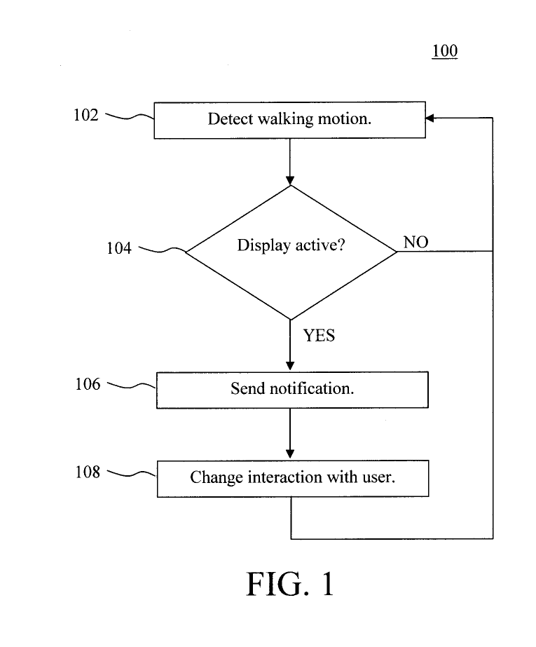

An overview of the present techniques is provided in FIG. 1. FIG. 1 depicts an exemplary methodology 100 for increasing user awareness when using a mobile device. In step 102, a walking motion is detected. As highlighted above, current mobile device technology typically incorporates a variety of different sensors that can detect motion of the user. For instance, an accelerometer can be used to detect a user's movement, speed and direction. A gyroscope sensor (often used in conjunction with an accelerometer) detects direction or orientation. A rate gyroscope similarly measures the rate of change of angle with time. A global positioning system or GPS provides location information. In other contexts, mobile technology has the capability, via the motion processor, to detect when a user is walking and determine, for example, how many steps the user has taken and/or how much distance the user has travelled, and what was the speed.

When a walking motion is detected, a determination is made in step 104 as to whether the display on the mobile device is actively projecting (visual) information to the user. The notion here is that any information displayed to the user on the mobile device can distract the user when the user is performing other activities such as walking and, according to the present techniques, the user will be forced to look away from the mobile device and become aware of his/her surroundings (see below). Any information displayed on the mobile device can trigger the present process. By way of example only, mobile devices often display general information (such as the time, date, weather conditions, etc.), notifications (such as text and email notifications). Mobile devices may also run mobile application (such as a texting app, an email app, an internet browser, GPS guidance apps, gaming apps, music streaming apps etc.). Any of these functions of the mobile device can be distracting to the user.

If it is determined in step 104 that (NO) the display on the mobile device is not actively projecting information to the user, then the process continues to monitor the device (in real-time) for distracting information on the display while the user is walking. By way of example only, in the case of apps run on the mobile device, this process serves to monitor the mobile device to detect if one of these apps is open and running (and assumes that the user is actively using the app on his/her mobile device).

On the other hand, if it is determined in step 104 that (YES) the display on the mobile device is actively projecting information to the user (e.g., data is being displayed to the user on the screen, at least one app is currently running on the mobile device, etc.), then in step 106 a notification is sent (e.g., from the motion processor) to the device. Upon receiving such a notification, in step 108 the mobile device (via its display) changes its interaction with the user in a manner that shifts the user's attention away from the mobile device and forces the user to be aware of the surrounding environment. Of particular importance is preventing the user from looking at the screen and/or touching the screen (in the case of a touch-screen mobile device) while walking. Other types of user interaction with the mobile device might be permitted, such as talking to the device which can be performed without looking at the device. Thus, the present techniques focus on modifying the way the device interacts with the user in terms of visual content.

A number of different ways are contemplated herein for increasing user awareness in this manner. For instance, in one exemplary embodiment (described below), the user's eye movements are used to determine where the user's attention is focused and the application will blank the screen if the user stares too long at it. In another case, the images on the mobile device screen will be shifted in a way that prompts the user to move (e.g., shake) the mobile device to bring the images back to the center of the screen. It is notable that all of the techniques provided herein are implemented only in response to a detection that the user is walking (step 102) and that the user is choosing to use his/her mobile device (YES in step 104). In light of such a situation, the present techniques can be implemented to shift the user's focus away from the mobile device in favor of his/her surroundings, and thereby minimize risk to the user.

Once the appropriate action has been taken to interact with the user, the process continues to monitor the situation in real time. For instance, if the user continues to walk and use their mobile device, then the process can be repeated to divert the user's attention away from the device, and be more aware of their surroundings. Further, by way of example only, the technique used in step 108 to interact with the user can be varied in subsequent iterations, in an attempt to better interact with the user. For instance, when walking and texting are detected, the first method of blanking the screen can be employed. While the same technique can be applied repeatedly, it might be advantageous to vary the interaction mechanism. Thus, when walking and texting is again detected, the app might instead shift the image on the screen prompting the user to move/shake the device (see below). The process may, in this manner, scroll through the various different interaction methods in a round-robin manner, or at random.

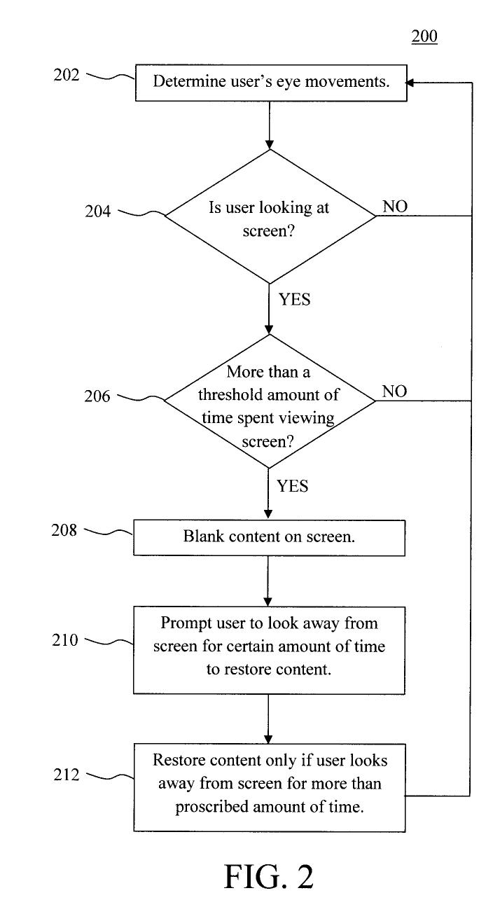

A first exemplary embodiment for changing the way the app interacts with the user (step 108) is now described by way of reference to methodology 200 of FIG. 2. Via methodology 100, it has been determined that the user is walking and that the user's mobile device is displaying information to the user. The question now is how the mobile device interacts with the user to make the user more aware of his/her surroundings (see description of step 108 of FIG. 1—above).

In this case, in step 202 a determination is made as to what direction the user is looking. This determination is important because if information is being displayed, but the user is not looking at his/her mobile device, then no immediate action may be needed.

Current mobile device technology typically includes one or more cameras capable of capturing still or video images. These cameras can be at various locations on the mobile device. For instance, in the case of a smartphone, a camera may be located on a front of the smartphone facing the user (i.e., when the user is viewing the screen on the smartphone this camera is pointing at the user). This enables the user to capture images (still or video) of him/herself. At least one other camera is also often located on a back of the smartphone (on a side of the smartphone opposite the screen). This enables the user to capture images (still or video) of subject matter in front of them. Further, mobile devices can also employ multiple cameras or image sensors which provides a depth perception capability. As is known in the art, these cameras can capture multiple images and determine the distance to a particular point in the images using the distance between the cameras and the viewing angle, both of which are fixed/known parameters.

In this particular example, the camera on the front of the mobile device (for capturing images of the user) is employed to determine the user's eye movements in step 202. The ability to detect user's eye movements via a mobile device and to perform tasks based on that detected eye movement, such as ‘scrolling,’ pausing video when a user looks away, etc. is known in the art and uses the user-facing camera to detect when the user is viewing the screen and at what angle. That technology is leveraged herein to determine in step 204 whether the user is looking at the screen of his/her mobile device. If it is determined in step 204 that (NO) the user is not looking at the screen, then no immediate action is needed, and the process continues to monitor the user's actions in real time.

On the other hand, if it is determined in step 204 that (YES) the user is viewing the screen on his/her mobile device (while walking—see above), then a determination is made in step 206 as to whether the user has been viewing the screen for more than a threshold period of time. Again, this determination can be made based on the eye movement sensing capabilities described above (i.e., whether the user's eye movements indicate that the user has been viewing the screen too long). The time limit can be a predetermined/preset threshold, e.g., a value from between about 2 seconds to about 5 seconds, and ranges therebetween. However, it may be preferable to set a variable threshold viewing time limit based on the circumstances, such as speed the user is walking, where the user is walking, etc. Data can be garnered from the above-mentioned mobile device sensors to determine these factors. For instance, the user might be walking briskly, but it is determined (e.g., via the GPS sensor) that the user is at home or at a gym and on a treadmill (i.e., their location does not change), then they are less likely to walk into an obstacle, than someone walking on a sidewalk or in a park, and the viewing time threshold can be adjusted accordingly.

If it is determined in step 206 that (NO) the user has not viewed the screen for more than the threshold amount of time, then the process continues to monitor the user's actions in real time. On the other hand, if it is determined in step 206 that (YES) the user has been viewing the screen more than the threshold amount of time, then in step 208, the mobile device will blank its screen. By blanking the screen it is meant that content viewed on the screen by the user is removed from the screen (i.e., it can no longer be seen by the user). This can involves removing all content from the screen (such that the screen is blank), or only select content such as the content related to a notification and/or to an app (e.g., texting, email, web browsing content, etc.).

The user is then prompted in step 210 to look away from the screen to restore the content to the screen. According to an exemplary embodiment, the user is provided with an instruction on the screen to look away from the screen (the user may be give a direction(s) to look away from the screen—which can be tracked via the user's eye movements) for a certain duration of time. As above, this duration can be preset (e.g., from about 2 seconds to about 5 seconds, and ranges therebetween) or can vary depending on the circumstances, e.g., speed user is walking, location, etc. Having a preset duration ensures that the user does not simply look away from the screen momentarily, but instead fully turns his/her attention away from the mobile device and towards his/her surroundings.

In step 212, the content is restored to the screen only when the user has looked away from the screen for more than the proscribed amount of time. The process then continues to monitor the user's action's (e.g., including eye movements) to ensure that he/she does not continue to stare at the screen.

As shown in FIG. 2, this process will repeat continuously as long as the user chooses to use his/her mobile device while walking. Thus, the user is likely to stop walking in order to be able to use the device without interruption.

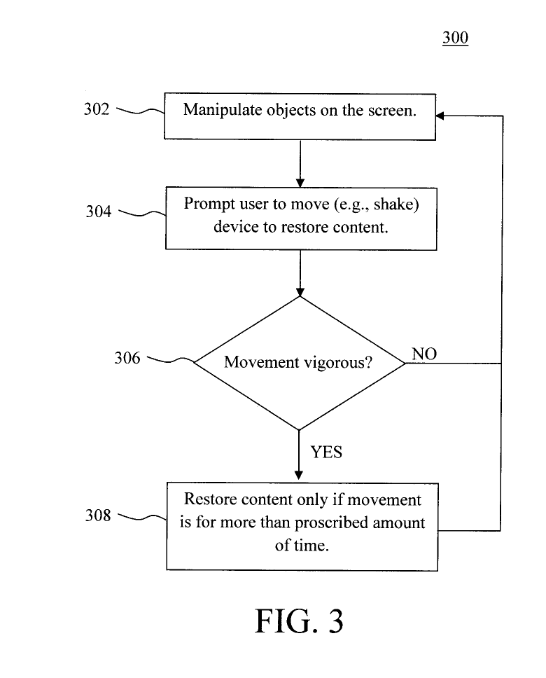

A second exemplary embodiment for changing the way the app interacts with the user (step 108) is now described by way of reference to methodology 300 of FIG. 3. Via methodology 100, it has been determined that the user is walking and that the user's mobile device is displaying some information to the user which may capture the user's attention and distract the user from his/her surroundings. Again, the question now is how the mobile device interacts with the user to turn his/her attention away from the mobile devices and thus make the user more aware of his/her surroundings (see description of step 108 of FIG. 1—above).

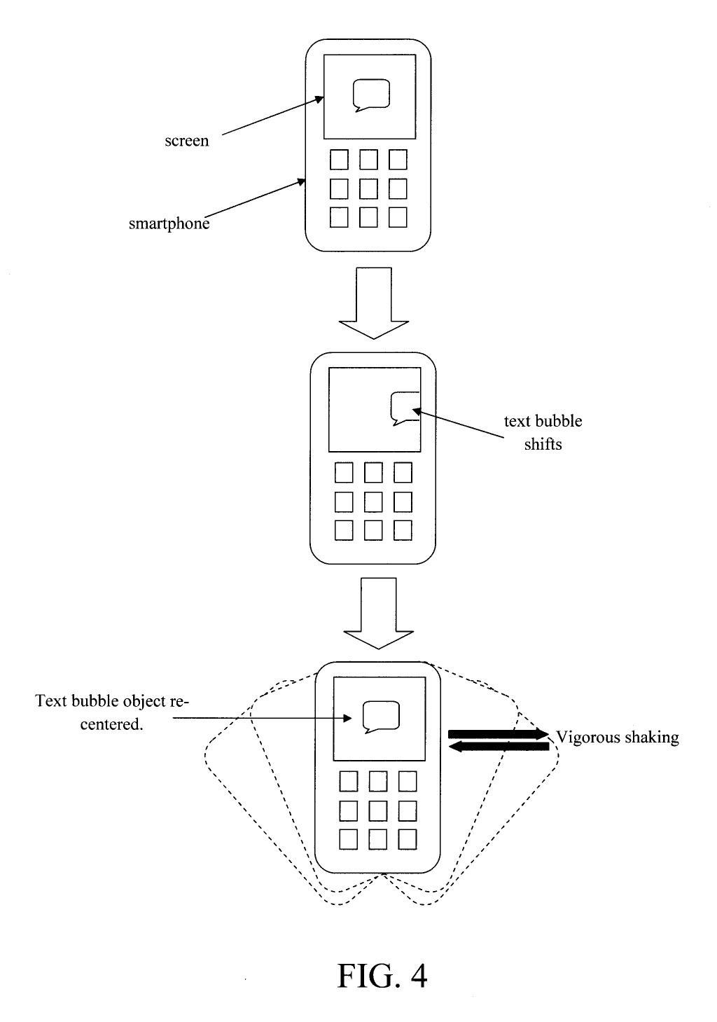

In step 302, information on the screen is manipulated in a manner that diverts the user's attention away from the screen. According to an exemplary embodiment, the information on the screen is manipulated in the following manner. Say, for example, that objects such as text bubbles are present on the screen. As is commonly known in the art, when texting, emailing, etc. on a mobile device, the conversion is typically contained in a sequence of text bubbles containing the correspondence, e.g., a schematic representation (also referred to as speech balloons) of a person's speech or thoughts. Similarly, content from a webpage may be displayed in a window or other similar viewing panel. In this example, when it is detected that the mobile device is being used while walking, the text bubbles, windows, etc. (or other content) that are displayed to the user are migrated to different sides (top, bottom, left, right) on the screen, or off of the screen entirely. See, for example, FIG. 4 which illustrates this principle using an example of a text bubble as an object. As shown in FIG. 4, (assuming walking while texting has been detected) the text bubble shifts to the right side of the screen (and in this case is partially off of the screen and thus cannot be read). Note that this is done only when it is determined (via the process outlined in FIG. 1) that the user is already viewing his/her mobile device while walking, i.e., if it is determined that the user is not walking and/or not using his/her device then no action is taken in this regard.

The natural tendency is for the user to want to bring these objects back onto the center of the screen. To do so, the user can be instructed (see step 304) to vigorously move (e.g., shake) the mobile device continuously for more than a certain length of time. Techniques are known in the art to manipulate objects on the screen of a mobile device based on a user physically moving (tilting, rotating, etc.) the device. To re-center the image on the screen, the user may be instructed (via a visual and/or audible message or prompt) to shake and/or move the device in some other manner by which the device cannot be used while this action is being performed. This will divert the user's attention away from the device in favor of his/her surroundings.

The moving/shaking must be performed vigorously and continuously for more than a certain (predetermined) length of time. Namely, a determination is made in step 306 as to whether the moving/shaking of the mobile device is being performed at a fast enough speed (i.e., at greater than a predetermined speed). For instance the user might, while holding the device in his/her hand, shake the device back and forth (see FIG. 4). The goal is to require an action in moving the device that is fast enough that the user cannot view the screen while the action is being performed. The rapidity of the motion can be determined using the accelerometer or motion processor capabilities of the mobile device. The rapidity of the motion can also be determined using the camera feature of the device. For instance, the camera on the back of the device (i.e., the camera facing away from the user when the user is viewing the screen) can capture a series of images at a certain time interval corresponding to how rapid a motion is required. The device can compare the images to determine whether they change from frame to frame in the series. If two images taken one after the other in the series are the same, then it may be determined that the shaking is not vigorous enough. Namely, when the device is shaken vigorously the images captured by the camera should be different from one another as the field of view of the camera should change rapidly. The time interval for capturing images that corresponds to a particular speed of motion could be determined by one skilled in the art given the present teachings.

If it is determined in step 306 that the moving/shaking is not vigorous enough, then the information will remain altered on the screen. On the other hand, if the requisite vigorous moving/shaking is performed by the user, in step 308 the content is restored only when the device has moved/shaken for more than the proscribed amount of time. The process then continues to monitor the user's action's to ensure that he/she does not continue to use the device while walking.

As shown in FIG. 3, this process will repeat continuously as long as the user chooses to use his/her mobile device while walking. Thus, the user is likely to stop walking in order to be able to use the device without interruption.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

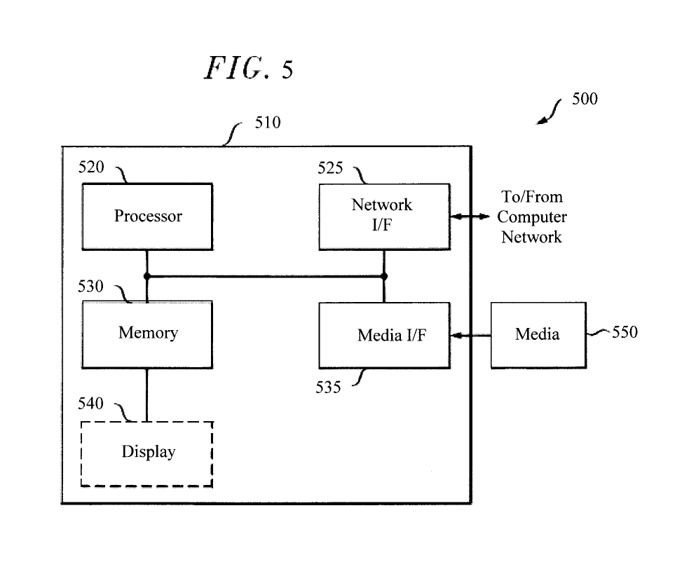

Turning now to FIG. 5, a block diagram is shown of an apparatus 500 for implementing one or more of the methodologies presented herein. By way of example only, apparatus 500 can be configured to implement one or more of the steps of methodology 100 of FIG. 1, one or more of the steps of methodology 200 of FIG. 2, and/or one or more of the steps of methodology 300 of FIG. 3.

Apparatus 500 includes a computer system 510 and removable media 550. Computer system 510 includes a processor device 520, a network interface 525, a memory 530, a media interface 535 and an optional display 540. Network interface 525 allows computer system 510 to connect to a network, while media interface 535 allows computer system 510 to interact with media, such as a hard drive or removable media 550.

Processor device 520 can be configured to implement the methods, steps, and functions disclosed herein. The memory 530 could be distributed or local and the processor device 520 could be distributed or singular. The memory 530 could be implemented as an electrical, magnetic or optical memory, or any combination of these or other types of storage devices. Moreover, the term “memory” should be construed broadly enough to encompass any information able to be read from, or written to, an address in the addressable space accessed by processor device 520. With this definition, information on a network, accessible through network interface 525, is still within memory 530 because the processor device 520 can retrieve the information from the network. It should be noted that each distributed processor that makes up processor device 520 generally contains its own addressable memory space. It should also be noted that some or all of computer system 510 can be incorporated into an application-specific or general-use integrated circuit.

Optional display 540 is any type of display suitable for interacting with a human user of apparatus 500. Generally, display 540 is a computer monitor or other similar display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for increasing user awareness during mobile device use, comprising:
detecting, by the mobile device, walking motion of the user; and
if the mobile device is displaying information to the user, shifting attention of the user away from the mobile device towards a surrounding environment.

2. The method of claim 1, wherein the mobile device is selected from the group consisting of: a smartphone, a smartwatch, and smartglasses.

3. The method of claim 1, wherein the information relates to an application currently running on the mobile device.

4. The method of claim 1, wherein shifting the attention of the user away from the mobile device towards the surrounding environment comprises:
determining whether the user is looking at a screen of the mobile device;
determining whether more than a threshold amount of time has been spent viewing the screen of the mobile device if it is determined that the user is looking at the screen of the mobile device; and
blanking content on the screen of the mobile device if it is determined that more than the threshold amount of time has been spent viewing the screen of the mobile device.

5. The method of claim 4, further comprising:
determining a direction the user is looking.

6. The method of claim 5, wherein the direction the user is looking is determined using a camera of the mobile device to analyze eye movements of the user.

7. The method of claim 4, wherein content on the screen of the mobile device has been blanked, the method further comprising:
prompting the user to look away from the screen of the mobile device for a given amount of time; and
restoring the content only if the user looks away from the screen of the mobile device for the given amount of time.

8. The method of claim 4, wherein blanking the content comprises removing all content from the screen of the mobile device.

9. The method of claim 4, wherein blanking the content comprises removing only select content from the screen of the mobile device.

10. The method of claim 1, wherein shifting the attention of the user away from the mobile device towards the surrounding environment comprises:
manipulating content on a screen of the mobile device; and
prompting the user to move the mobile device to restore the content.

11. The method of claim 10, wherein manipulating the content on the screen of the mobile device comprises:
moving objects displayed on the screen to one side of the screen of the mobile device; and
restoring the objects to a center of the screen when the user moves the mobile device.

12. The method of claim 11, wherein moving the objects comprises moving the objects at least partially off of the screen of the mobile device.

13. The method of claim 10, further comprising the step of:
prompting the user to shake the mobile device to restore the content.

14. The method of claim 13, further comprising the step of:
determining whether the mobile device is being shaken at greater than a predetermined speed.

15. The method of claim 14, further comprising the step of:
using motion sensors of the mobile device to determine whether the mobile device is being shaken at greater than the predetermined speed.

16. The method of claim 14, further comprising the steps of:
capturing a series of images using a camera of the mobile device; and
analyzing the images to determine whether the mobile device is being shaken at greater than the predetermined speed.

17. A non-transitory computer-readable program product for increasing user awareness during mobile device use, the computer program product comprising a computer readable storage medium having program instructions embodied therewith which, when executed, cause a computer to:
detect, by the mobile device, walking motion of the user; and
if the mobile device is displaying information to the user, shift attention of the user away from the mobile device towards a surrounding environment.

18. The computer program product of claim 17, wherein the program instructions when shifting the attention of the user away from the mobile device towards the surrounding environment further cause the computer to:
determine whether the user is looking at a screen of the mobile device;
determine whether more than a threshold amount of time has been spent viewing the screen of the mobile device if it is determined that the user is looking at the screen of the mobile device; and
blank content on the screen of the mobile device if it is determined that more than the threshold amount of time has been spent viewing the screen of the mobile device.

19. The computer program product of claim 17, wherein the program instructions when shifting the attention of the user away from the mobile device towards the surrounding environment further cause the computer to:
manipulate content on a screen of the mobile device; and
prompt the user to move the mobile device to restore the content.

20. An apparatus for increasing user awareness during mobile device use, the apparatus comprising:
a memory; and
at least one processor device coupled to the memory, the processor being operative to:
detect, by the mobile device, walking motion of the user; and
if the mobile device is displaying information to the user, shift attention of the user away from the mobile device towards a surrounding environment.
